(19) United States
(12) Patent Application Publication
(10) Pub. No.: US 2016/0247490 A1
(43) Pub. Date: Aug. 25, 2016

(54) CAPO

(71) Applicant: C7th Limited, Peterborough (GB)

(72) Inventors: Nicholas John Campling, Peterborough (GB); Christopher Noel Sheehan, Leicestershire (GB); Simon John Campling, Peterborough (GB)

(21) Appl. No.: 14/924,314

(22) Filed: Oct. 27, 2015

(30) Foreign Application Priority Data
Nov. 4, 2014 (GB) 1419632.3

(51) Int. Cl. G10D 3/04

(52) U.S. Cl. CPC G10D 3/043

(57) ABSTRACT

A capo for use with a guitar includes a clamp arm, a contact element and an opposing element to provide a clamping force via the contact element over the strings. A flowable material such as a fluid, gel or paste is retained in a cavity behind the contact element so that it can adjust to the curvature of the guitar and strings which otherwise vary between instruments and dependent on string gauge.

This application claims foreign priority benefits under 35 U.S.C. §119(a)-(d) to GB 1419632.3, filed Nov. 4, 2014, which is incorporated by reference in its entirety.

### TECHNICAL FIELD

The present invention relates to a capo for a stringed instrument such as a guitar or banjo. Particularly, the capo is intended to be able to adapt to the curvature of a finger board and/or strings to which it is applied.

### BACKGROUND

A capo (sometimes referred to as a capodastro, capodaster, capotasto or cejilla) is a well-known device used with a stringed instrument having a neck and a set of strings extending along the length of the neck. The capo, when applied to an instrument neck, serves to clamp the strings against a finger board and, in particular, between or against one of the number of fret bars disposed along the length of finger board. In practice, a capo serves to reduce the effective length of the strings and therefore adjust the pitch; i.e. the pitch is raised as the effective length of a string is shortened.

A large number of different capo types are known, each of which has a different advantage or technical consideration. However, most standard capo designs feature a relatively rigid clamping bar which reaches over the strings in order to apply downward pressure thereon. The clamping bar is usually a metal material with a rubber contact surface which has some resilience in order to accommodate strings and any minor curve across the instrument's neck. However, guitar finger boards vary in the radius that is desirable, ranging from flat on a classical style instrument to a radius of approximately 7.25 inches (18.4 cm) on some electric guitars. Many contemporary steel-string acoustic guitars have a radius across the finger board of 12 to 14 inches (30.5 to 35.6 cm). It is also known to apply a varying (compound) radius along the length of the finger board.

The radius of a finger board is also affected by the gauge of strings used on the instrument. For example, as illustrated in FIG. 1 of the accompanying drawings, a guitar neck N is shown having a finger board B and associated fret F with a radius which is effectively offset to one side by the gauge of the strings which increase in diameter (in order to produce lower frequencies) from right to left across the six strings S. The configuration could be reversed dependent on whether the instrument is left or right handed. As will be noted by a skilled person, FIG. 1 effectively shows all strings S pressed against fret F of the finger board B, as with a capo applied.

It will be apparent that the radius of any capo clamping arm designed for pressing with even pressure against the finger board/fret, to enable strings to come into solid contact with a fret and avoid any “buzzing” of the strings, must take this into account. A common way for capo makers to address this problem is to use a resilient material such as rubber to press onto the strings. This allows the strings to press into the rubber locally and at a relatively even pressure between the strings. However, it is well known that this approach is only partially effective and can result in too much pressure on some strings, leading to sharp notes.

The player may compensate for the above by adjusting the tuning, although clearly this is not ideal because it would prohibit a quick changeover during a performance when applying the capo or adjusting its position along the guitar neck.

The use of softer rubber can provide more flexibility/accommodation in the capo properties and adaptability to different curvatures, but soft rubber is also known to deaden the tone of guitar strings to some extent.

### SUMMARY OF THE INVENTION

The present invention seeks to provide a means of enabling equal pressure across the strings, which also accounts for curvature in the finger board. According to a broad aspect of the invention a capo for a stringed instrument is provided according to claim 1.

The invention involves building a flowable material/medium (e.g. a fluid, gel, paste or equivalent type of substance with embedded solid particles), preferably contained within a chamber, into the clamping arm behind a hard layer made from a firmer, but still adaptable, material (e.g. rubber) that may be in close contact with the strings. The harder material must provide a solid surface that isolates the strings from the flowable medium behind it. If the flowable medium were enclosed only by a soft material wall that, in turn, was in contact with the strings then a dampening of tone would result.

Preferably the fluid or gel is enclosed/encased on all sides so that it can adapt to a shape pressed against it, via the contact surface or element. Preferably the chamber with flowable material will extend across a substantive length of the clamping arm, at least coinciding with the location of strings on the instrument. The sealed chamber can be interchangeably referred to as a cavity, void or hollow and may take the form of a bellows or collapsible wall type structure.

Due to its effectively incompressible nature the flowable medium maintains an even pressure over the strings. This is possible because the flowable medium is preferably constrained by unyielding walls on all sides, except the side in proximity to the contact surface. In practice the flowable material can flow sideways so as to equalise the pressure causing the string contact surface to move in one plane. As the capo clamp is tightened the contact surface is preferably able to flex and maintain an even force when it has taken its flexed shape. In any event, it will be apparent that the volume occupied by the flowable medium does not substantially change. For example, even embodiments that allow for a certain “bulging” of side walls surrounding the medium can achieve the advantages of the invention. Likewise, while a gas medium would be compressed slightly and result in a volume decrease, it is not expected that this would prevent the mechanism of the invention from working. Indeed, compressibility of the medium can be accounted for in the design to ensure that, for example, the contact surface did not curve so severely as to touch the upper wall of the chamber. In a preferred form of the invention the flowable medium may be a soft elastomer (gel) which is static/solid at room temperature but very soft so as to be effectively flowable when subject to pressure. Such a material, like silicone, is relatively cheap and avoids the need for containing an oil or similar liquid medium to achieve the purpose of the invention. A soft elastomer such as the silicone rubbers used for special effects makeup in the film industry, or common ear plugs, can be any hardness depending on the formulation and cast or moulded into very pliable components, e.g. as soft as Shore 00-10.

The contact surface is a separate component from the flowable material and must have a solid/stiff quality provided by a certain thickness and/or hardness in order to provide a suitably firm surface against which the strings are clamped. Preferably the element will be resilient, i.e. capable of springing back to shape but, more importantly, it will provide a hard surface (relative to the flowable material and many string contacting members found in the prior art) for contact with the strings while being capable of bending to the sum curvature of the finger board/fret plus strings.

The term “flowable medium” has been chosen because it generally refers to a substance such as a fluid, i.e. a semi-solid, liquid or gas, that is capable of flowing and that changes its shape at a steady rate when acted upon by a force tending to change its shape. In practice a liquid or gel will be relatively incompressible in the context of the present invention, however, it is expected that a sealed gas pocket could also perform the function of the invention, namely to adapt to the curvature of a particular instrument neck when the capo is applied. As mentioned, it is expected that a gel is a particularly advantageous embodiment of flowable medium according to the invention. In practice a gel could flow with minimal disturbance (such as the consistency of hair gel which should be contained in a sealed bag) or be a very soft elastomeric material able to return to its original shape. The latter example is preferable in the context of the invention. According to a second broad definition of the invention, there is provided a clamping arm according to claim 12.

The invention, as an integral component of a clamping arm, can be incorporated into any type of capo, for example (but not limited to) a spring, clutch, elastic or screw tightened device.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a guitar neck cross section well known in the prior art;

FIG. 2 illustrates a general view of a capo which may incorporate the present invention;

FIG. 3 illustrates a cross section view of a capo according to the invention during a first step of applying to a guitar neck;

FIG. 4 illustrates a cross section view of a capo according to the invention during use;

FIG. 5 illustrates an alternative form of the invention;

FIG. 6 illustrates another embodiment of capo according to the invention;

FIG. 7 illustrates a yet further embodiment of capo according to the invention; and,

FIGS. 8 and 9 illustrate cross section end view embodiments where a retaining sleeve is formed over the capo clamping arm.

### DETAILED DESCRIPTION

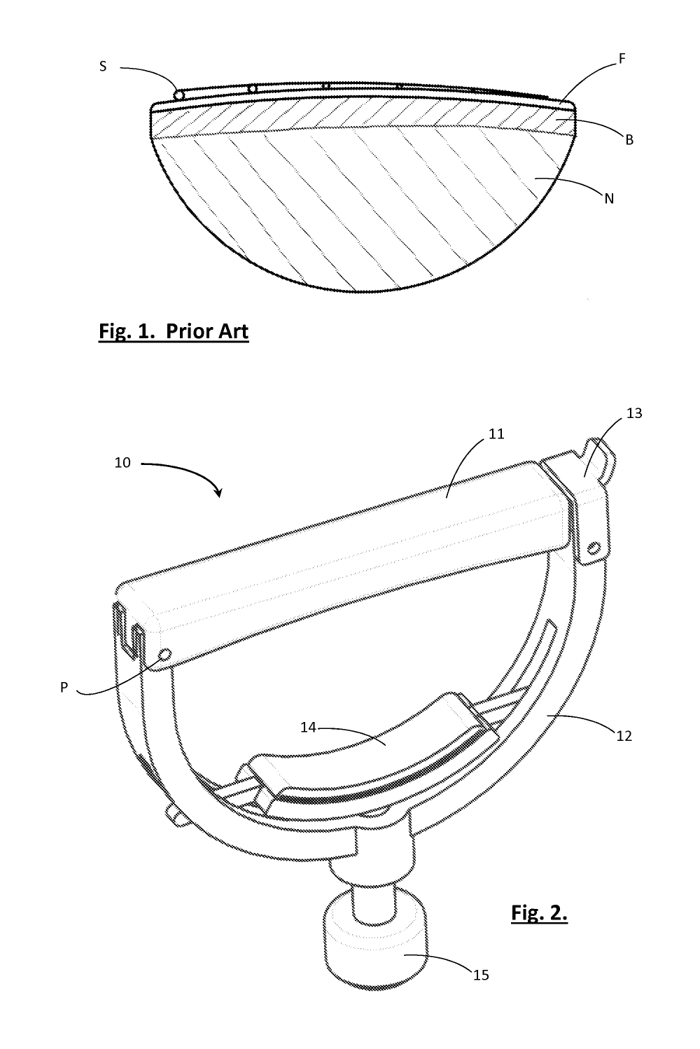

FIG. 2 illustrates a general view of a capo 10 that may incorporate the present invention into a clamping arm 11 which is pivotally mounted at axis pin P to a U-shaped arm/body 12 and held closed by a latch 13. It will be apparent to those skilled in the art that the capo 10 illustrated in FIG. 2 can be applied to a guitar neck N of the type illustrated by FIG. 1 by simply releasing the catch, swinging clamp arm 11 upwards on its pivot P and confining the neck between a curved pad 14 associated with the U-shaped body 12 and the closed clamping arm 11, as illustrated in FIG. 3.

During use a tightening means, e.g. threaded member manipulated by knob 15, is tightened to press the curved pad 14 against the curvature of neck N. In most cases, experience of the player will dictate how tight the threaded member 15 should be in order to provide the required tonal characteristics.

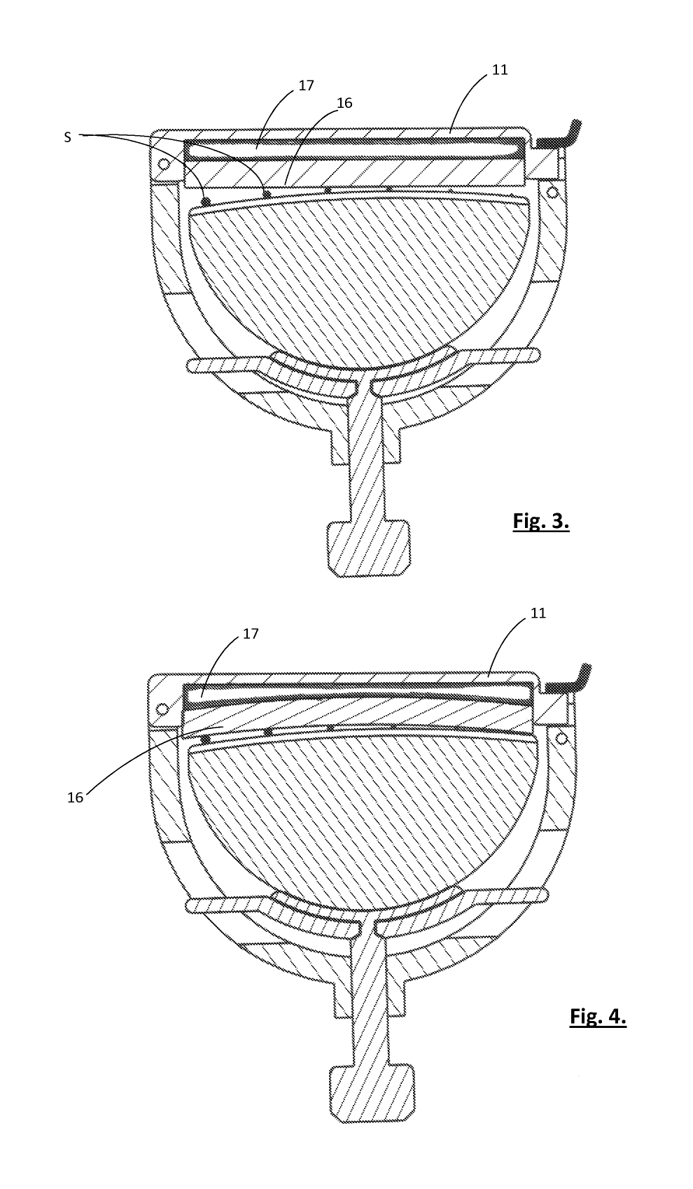

The nature of the invention is best described by reference to FIGS. 3 and 4, wherein the underside of clamp arm 11 includes a contact surface 16 which, in practice, will be pressed into engagement with the strings S. The contact surface is preferably an element 16 with resilient properties but also rigidity, e.g. moulded from a suitable hard rubber or plastic material. Element 16 should be flexible in order to adapt to curvature of the strings plus frets, although it is not essential to spring back to its original shape, so long as a new shape can be assumed.

Clamping arm 11 itself is most likely a relatively rigid cast, pressed or moulded material (e.g. metal or hard plastic), including an elongate chamber or cavity 17 behind the contact element 16 and, particularly, providing a gap to accommodate any changes in the effective shape of contact element 16. According to the invention, cavity 17 is preferably sealed itself or otherwise retains therein an amount of flowable material or a substantially sealed bag/pocket containing flowable medium. The flowable medium could be contained in a capsule or other suitably sealed structure, located behind contact element 16. In alternative embodiments the cavity 17 or an equivalent enclosure could be incorporated into a contact element 16 as a pocket, which is in turn received or connected to the clamp arm. In any event the contact surface/element 16 must provide a hard barrier between the strings and the flowable medium that isolates the strings and prevents a direct impression into the flowable medium. This helps to preserve tone in the strings.

In a primitive form of the invention, the contact element may be rigidly flat or have a built-in curve such that the flowable material provides only a degree of movement to tilt the element 16 to one side, thereby adapting to the string gauge gradient illustrated in FIG. 1 and not necessarily the full curvature of the finger board.

It is well known that non-gaseous substances are, in practice, incompressible but in the context of the invention the flowable medium will allow an adjustment to any curved shape pressed into it and return an even force against the finger board/fret/strings. The material retained within chamber 17 is capable of flowing and changing its shape at a steady rate when acted upon by an external force; i.e. the clamping force delivered via contact element 16.

Contact element 16 may be backed by a harder, but springy, material such as a sheet spring steel or acetal strip but, in any event, as the capo is tightened by virtue of knob 15, the strings push against the contact surface which, in turn, pushes against the gel, fluid capsule or equivalent structure. Fluid is forced to redistribute within the sealed chamber and will effectively provide outward pressure against the strings in places that would not otherwise be in contact by a non-adaptive system.

Eventually the contact surface will conform to the curve across the strings (dictated by the string gauge and neck construction) and configure to whatever shape is necessary to equalise pressure throughout the flowable material. In this sense, the invention provides infinite variability within the dimensional constraints designed into the clamp arm construction.

FIG. 4 best illustrates the nature of the invention once in place and ready for use. It is clear that the contact element 16 has flexed to adopt a curved shape generally in accordance with the string gauge and finger board radius, supported by the flowable medium occupying gap 17. Ultimately, pressure on the strings is controlled by the threaded member 15 which is adjusted according to experience or guidance given by instructions or, possibly, indicators built into the device. As previously mentioned, the exact form of adjustment and means of applying the capo is not limited by the invention such that other spring loaded clutch or strap-type means could be incorporated in place of the latch 13 and body structure 12.

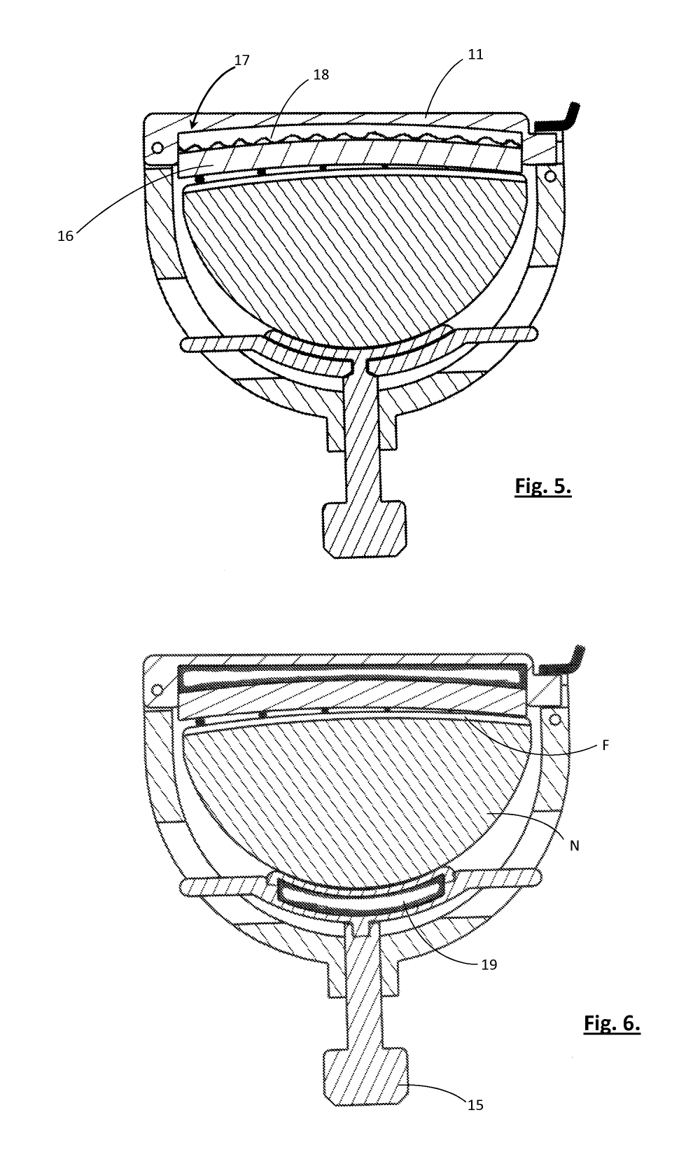

FIG. 5 illustrates an alternative embodiment where the cavity 17 is not necessarily sealed and accommodates a soft gel or like material which can have moulded therein a series of ridges/ribs 18 which, it is proposed, may assist in accommodating changing curvature in the contact element 16 as the gel “flows”. However, ridges/ribs 18 are not an essential feature of the invention and the embodiments illustrated by other drawings may also utilise a gel as the flowable medium within cavity 17.

In the illustrated form the gel is soft but not actually a fluid and, as such, the invention is not intended to be limited to a fluid only. The gel will also be effectively incompressible and adopts a shape moving away from points of high pressure, towards low pressure points or equilibrium within the gel that is more or less a uniform pressure as the capo is tightened against the strings. Gels of this type are not susceptible to leaking and therefore do not need to be contrained by a sealed cavity. Silicone is a suggested material which could perform the required properties of the invention.

FIG. 6 illustrates a variation on the embodiment from FIGS. 3 and 4 where a second fluid or gel-filled cavity is incorporated into the pad (14) in contact with the rear of the guitar neck N. Such a construction helps to provide even clamping pressure against the rear of the neck which also can have a range of radius/curvature depending on the instrument. The pad also helps to cater for any misalignment as the user applies the capo to a guitar. As mentioned, many other types of clamping mechanism are possible such that the second fluid or gel-filled cavity or capsule could be incorporated into the lower arm of a spring or clutch capo.

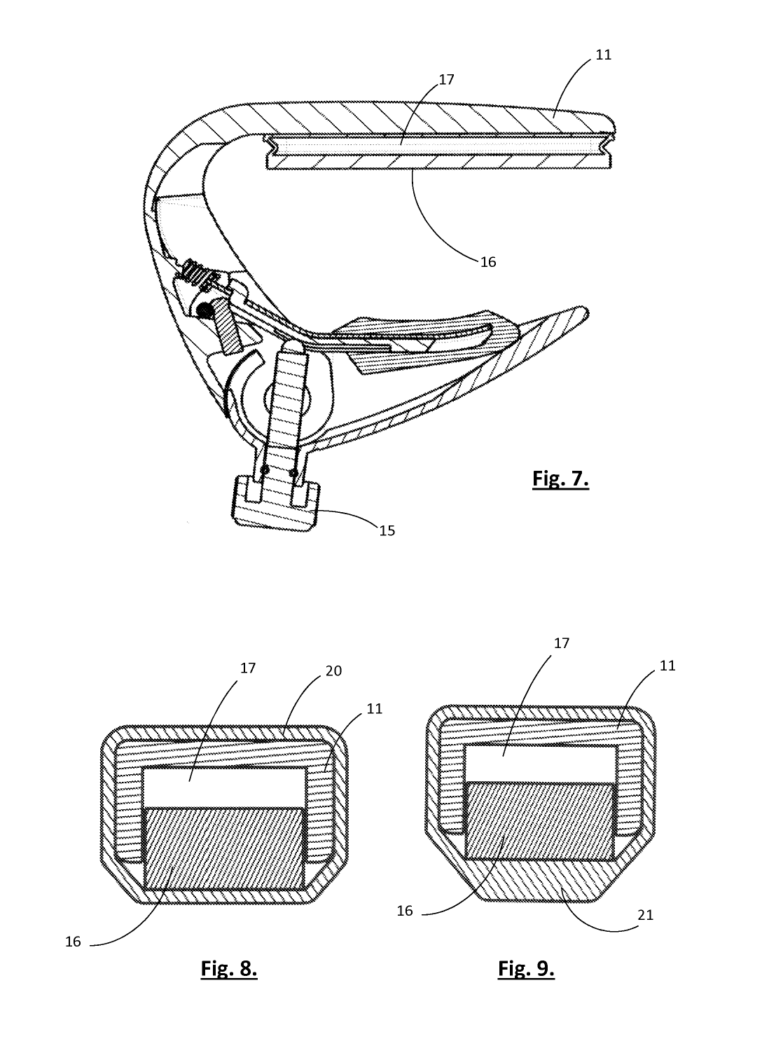

FIG. 7 illustrates a further embodiment of the invention where a bellows shaped chamber 17 is located behind the contact surface 16. This component could be formed/moulded from one piece and adhered to the clamping arm 11 of the capo.

A concertina or collapsible-walled structure of this type is intended to allow expansion/contraction in primarily one plane and, in the context of the invention, the contact surface 16 will conform to a required curvature while force is exerted evenly onto a fingerboard/strings. Furthermore, the relatively rigid nature of the contact surface isolates the strings from the soft nature of the flowable medium within to preserve tone.

Chamber 17 provides a void that can be filled with air/gas or liquid or gel as previously described.

FIGS. 8 and 9 illustrate variations on an embodiment where a retaining sleeve 20 is formed over the clamping arm 11. The sleeve 20 is likely to be a rubberised material that holds the previously described components, e.g. the flowable material 17 and resilient element/contact surface 16, together in a secure manner. Referring to FIG. 8, it will be apparent that the underside of sleeve 20 is effectively in contact with the strings (not illustrated) in use but that, no matter what the actual hardness of the sleeve 20, it is still associated with a harder resilient element 16 which provides isolation from medium 17. Therefore, even if sleeve 20 were relatively soft then the principles of the invention are maintained.

FIG. 9 shows an embodiment where sleeve 20 is formed from a rubber/plastic with an integral thickened portion 21 on the underside which can serve as the hard material isolating the strings from the flowable medium 17, with or without the presence of a resilient element 16.

In any event, it is a consideration of the invention that the string contact surface must be either made from or closely associated with a harder material layer 16 so that the flowable material 17 (such as a gel or paste) is not directly in contact with the strings which could cause a deadening of the tone.

It will be apparent that the capo according to the invention can be fabricated/manufactured from available materials and techniques dictated by various considerations such as cost and durability.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A capo for use with a stringed instrument having a neck with a back and a finger board with strings that extend longitudinally over said finger board, the capo comprising:
a first arm configured to, in use, extend laterally across the finger board over the strings;
a contact surface for contacting the strings in use; and
an opposing element configured to, in use, abut against the back of the neck of the instrument to, in cooperation with the first arm, provide a clamping force via the contact surface over the strings;
a flowable medium located behind the contact surface;
wherein the contact surface is associated with a layer of hardness that isolates the strings from direct impression on the flowable medium behind it.

2. The capo of claim 1 wherein the flowable medium is a gas, liquid, gel or paste.

3. The capo of claim 1 wherein the flowable medium is encapsulated.

4. The capo of claim 1 wherein the flowable medium is constrained by rigid walls on all sides but the side in proximity to the contact surface.

5. The capo of claim 1 wherein the flowable medium is retained by a collapsible-walled structure.

6. The capo of claim 1 wherein the contact surface is flexible and/or resilient in order to adapt to the combined curvature of finger board and strings.

7. The capo of claim 6 wherein the contact surface is rubber or plastic.

8. The capo of claim 1 wherein the contact surface is constructed from composite layers.

9. The capo of claim 1 wherein the flowable medium is made from a soft elastomer.

10. The capo of claim 9 wherein the elastomer is moulded with ridges or ribs formed in at least one surface.

11. The capo of claim 1 wherein the opposing element has incorporated therewith a flowable medium adjacent a neck abutting portion.

12. The capo of claim 1 wherein the opposing element is a second arm, strap or body element, cooperable with the first arm to provide a clamping force on the neck and strings of the instrument.

13. A clamping arm for a capo for a stringed instrument comprising:
a contact surface for contacting the strings of an instrument in use; and
a flowable medium located, relative to strings of the instrument, behind the contact element; wherein
the contact surface is associated with a layer of hardness that isolates the strings from direct impression on the flowable medium behind it.

14. The clamping arm of claim 13 wherein the contact surface is resilient and/or flexible.

15. The clamping arm of claim 13 wherein the flowable medium is retained in a chamber.

16. The clamping arm of claim 13 wherein the flowable medium is a gel.
